(19) United States
(12) Patent Application Publication
(10) Pub. No.: US 2010/0173011 A1
(43) Pub. Date: Jul. 8, 2010

(54) DISINFECTANT CLEANING COMPOSITION AND METHOD

(76) Inventors: Donald S. Peters, Aurora, OH (US); Joseph J. Sidari, Cleveland, OH (US)

Correspondence Address: ROETZEL & ANDRESS, 1375 EAST 9TH STREET, CLEVELAND, OH, 44114, US

(21) Appl. No.: 12/572,917

(22) Filed: Oct. 2, 2009

Related U.S. Application Data
(63) Continuation-in-part of application No. 11/893,433, filed on Aug. 16, 2007.
Application No. 11/893,433 is a continuation-in-part of application No. 11/827,725, filed on Jul. 14, 2007.

(51) Int. Cl. C11D 9/42; A01N 59/00; A01P 1/00

(52) U.S. Cl. 424/616; 510/372; 510/102; 510/103; 510/101

(57) ABSTRACT

The present invention relates to the field of cleaning compositions for cleaning various surfaces, and to a method of cleaning such surfaces. In one embodiment, the present invention relates to surface cleaning compositions which include a disinfectant and a method of cleaning surfaces such as hard and soft surfaces.

### RELATED APPLICATION DATA

This patent application claims priority to and is a continuation-in-part of U.S. patent application Ser. No. 11/893,433, filed Aug. 16, 2007 and entitled “Disinfectant Cleaning Composition and Method,” which is itself a continuation-in-part of U.S. patent application Ser. No. 11/827,725, filed Jul. 14, 2007 and entitled “Disinfectant Cleaning Composition and Method.” Both of the aforementioned United States Patent Applications are hereby incorporated by reference herein in their entireties.

### FIELD OF THE INVENTION

The present invention relates to the field of cleaning compositions for cleaning various surfaces, and to a method of cleaning such surfaces. In one embodiment, the present invention relates to surface cleaning compositions which include a disinfectant and a method of cleaning surfaces such as hard and soft surfaces.

### BACKGROUND OF TE INVENTION

A variety of cleaning formulations are available for household use on hard surfaces such as countertops, tiles, kitchen and bathroom fixtures, for example. Several considerations in formulating such compositions include the cleaning ability to dissolve stains and dirt as well as disinfect the surfaces that they contact.

Despite their convenience, several conventional cleaning formulations suffer from a number of disadvantages. Disinfectant compositions used on hard surfaces such as countertops, plumbing fixtures in kitchens and bathrooms, such as porcelain and plastic plumbing fixtures, for example, are acidic or caustic and can damage the substrates to which they are applied. The cleaning compositions can also present safety or health hazards to the user. For example, they may irritate the eyes and nose and mucous membranes. Most restaurant kitchens must employ hot water for cleaning surfaces which come into contact with food, however the water may not be hot enough to kill bacteria or prevent its growth. Hot water is also limited in its ability to effectively cut grease. Other cleaning compositions are volatile and evaporate from the surface before the substrate is effectively disinfected or cleaned.

There remains a need for alternative cleaning compositions useful in removing stains and/or odor as well as disinfecting surfaces without imparting harmful and toxic exposure to those who use or come into contact with the products.

### SUMMARY OF THE INVENTION

The present invention relates to the field of cleaning compositions for cleaning various surfaces, and to a method of cleaning such surfaces. In one embodiment, the present invention relates to surface cleaning compositions which include a disinfectant and a method of cleaning surfaces such as hard and soft surfaces.

In one embodiment, the present invention provides for excellent cleaning compositions that can be used on various surfaces for disinfecting and improved cleaning of surfaces while also being safe to use and environmentally benign. The surface cleaning compositions herein are odorless, non-toxic, non-flammable, and bio-degradable.

In one embodiment, the present invention relates to a cleaning composition comprising: from about 0.5% to about 15% by weight hydrogen peroxide; from about 1.5% to about 75% by weight aloe vera and/or at least one antibacterial, antifungal and/or antiviral active component thereof; and from about 99% to about 10% by weight of at least one solvent. In this embodiment, the cleaning composition optionally includes from about 0.1% to about 10% of at least one thickener, optionally includes, by weight, from about 0.1% to about 10% of at least one preservative, and/or optionally includes, by weight, from about 0.1% to about 10% of at least one chelating agent/compound, where such additional components are in place of a similar amount of solvent.

In another embodiment, the present invention relates to a cleaning composition comprising: from about 1% to about 15% by weight hydrogen peroxide; from about 2% to about 65% by weight aloe vera and/or at least one antibacterial, antifungal and/or antiviral active component thereof; and from about 98% to about 20% by weight solvent. In this embodiment, the cleaning composition optionally includes from about 0.1% to about 10% of at least one thickener, optionally includes, by weight, from about 0.1% to about 10% of at least one preservative, and/or optionally includes, by weight, from about 0.1% to about 10% of at least one chelating agent/compound, where such additional components are in place of a similar amount of solvent.

In still another embodiment, the present invention relates to a cleaning composition comprising: from about 2% to about 6% by weight hydrogen peroxide; from about 2.5% to about 60% by weight aloe vera and/or at least one antibacterial, antifungal and/or antiviral active component thereof; and from about 96% to about 34% solvent. In this embodiment, the cleaning composition optionally includes from about 0.1% to about 10% of at least one thickener, optionally includes, by weight, from about 0.1% to about 10% of at least one preservative, and/or optionally includes, by weight, from about 0.1% to about 10% of at least one chelating agent/compound, where such additional components are in place of a similar amount of solvent.

In still yet another embodiment, the present invention relates to a cleaning composition comprising: from about 1% to about 10% by weight hydrogen peroxide; from about 1.5% to about 50% by weight aloe vera and/or at least one antibacterial, antifungal and/or antiviral active component thereof; from about 0.05% to about 5% by weight fragrance; and from about 97.5% to about 35% by weight solvent. In this embodiment, the cleaning composition optionally includes from about 0.1% to about 10% of at least one thickener, optionally includes, by weight, from about 0.1% to about 10% of at least one preservative, and/or optionally includes, by weight, from about 0.1% to about 10% of at least one chelating agent/compound, where such additional components are in place of a similar amount of solvent.

In still yet another embodiment, the present invention relates to a cleaning composition comprising: from about 25% to about 35% by weight of at least one alkali percarbonate or other hydrogen peroxide producing source; from about 25% to about 35% by weight of at least one alkali carbonate; from about 35% to about 25% of aloe vera or at least one active ingredient thereof; and from about 15% to about 5% of at least one surfactant.

In still yet another embodiment, the present invention relates to a method for cleaning a substrate comprising the step of: contacting a cleaning composition to a surface, wherein the cleaning composition comprises: from about 0.5% to about 15% by weight hydrogen peroxide; from about 1.5% to about 75% by weight aloe vera and/or at least one antibacterial, antifungal and/or antiviral active component thereof; and from about 99% to about 10% by weight of at least one solvent. In this embodiment, the cleaning composition optionally includes from about 0.1% to about 10% of at least one thickener, optionally includes, by weight, from about 0.1% to about 10% of at least one preservative, and/or optionally includes, by weight, from about 0.1% to about 10% of at least one chelating agent/compound, where such additional components are in place of a similar amount of solvent.

### DETAILED DESCRIPTION OF THE INVENTION

The present invention relates to the field of cleaning compositions for cleaning various surfaces, and to a method of cleaning such surfaces. In one embodiment, the present invention relates to cleaning compositions which include a disinfectant and a method of cleaning surfaces such as hard and soft surfaces.

The compositions herein are used to treat a variety of surfaces, for example, hard surfaces typically found in residential or commercial kitchens and bathrooms, including but not limited to chrome and porcelain, and also soft surfaces, such as those of furniture and automobile interiors, including but not limited to, textiles, fabrics and/or carpeting. Other examples of hard surfaces include tiles, walls, floors, chrome, glass, vinyl, plastic, laminated wood of table tops, sinks, dishes, sanitary fittings used in sinks and showers, shower curtains, wash basins, etc. Hard-surfaces also include household appliances including, but not limited to, refrigerators, freezers, washing machines, automatic dryers, ovens, microwave ovens, cook-tops, dishwashers and so on. Furthermore, the disinfectant compositions are also used for hard-surfaces found in public places such as hospitals, restaurants, hotels, public transport vehicles, public pools and showers and commercial and public laundries, for example. Additionally, various embodiments of the present invention can be used as personal care products for the use on, for example, various skin surfaces. In still another instance, various embodiments of the present invention yield disinfectant compositions that can, to a variety of levels, disinfect various surfaces.

In one embodiment of the present invention, the cleaning composition comprises hydrogen peroxide, H₂O₂, aloe vera and/or at least one active ingredient thereof and at least one solvent. Although not wishing to be bound to any particular active ingredient, it is believed that the active ingredient is at least one or more of the components found in the aloe vera plant described below. In one embodiment of the present invention, the cleaning composition are odorless, non-toxic, non-flammable and bio-degradable.

In another embodiment the cleaning composition is substantially free of acids, caustics and bleaches, for example, as well as other substances which may be detrimental to the surface finish or color of the substrate or detrimental to the health of the user. By the term “substantially free of” it is meant that there is less than about 0.7%, and in another example, less than about 0.3%, and in another examples, less than about 0.05% by weight of a substance in the cleaning composition.

Both hydrogen peroxide, H₂O₂, and aloe vera and/or at least one active ingredient thereof, can provide anti-microbial action against micro-organisms. The hydrogen peroxide is an oxidizer that generates hydroxyl free radicals which attack proteins and nucleic acids within micro-organisms cells. Furthermore, the presence of hydrogen peroxide provides good stain removal capabilities, for example, when applied to a hard surface for cleaning. An advantage of hydrogen peroxide is that it can provide an effervescent action which can irrigate the surface to which it is applied. Hydrogen peroxide can be effective with mechanical flushing or rinsing action once applied to further clean a surface.

Hydrogen peroxide can be provided as a liquid mixture of hydrogen peroxide and water, e.g. as liquid hydrogen peroxide in an aqueous solution. Hydrogen peroxide is commercially available at various concentrations including, but not limited to, 3%, 6%, 35%, 50%, 70% and 90% in water. For safety, 35% or less hydrogen peroxide solution is commonly provided.

It has been found that aloe vera and/or at least one active ingredient thereof is both an excellent disinfectant and emulsifier. The aloe vera and/or at least one active ingredient thereof has anti-viral, anti-bacterial and anti-fungal properties. It has also been found surprisingly that the aloe vera and/or at least one active ingredient thereof, in conjunction with the hydrogen peroxide, emulsifies the stain or soil, for example, food, grease or dirt from the substrate so that it can be removed.

Aloe vera which originates from the aloe vera plant, has several constituents. The aloe vera comprises amino acids, anthraquinones, enzymes hormones, lignin, minerals, vitamins, salicylic acid, saponins, sterols and sugars. The anthraquinones include the following: aloe emodin, aloetic acid, aloin, anthracine, antranol, barbaloin, chrysophanic acid, emodin, etheraeal oil, ester of cinnamonic acid, isobarbaloin and resistannol. The anthraquinones are found in the sap of the aloe vera plant. The anthraquinones can provide analgesic, antibacterial, antifungal and antiviral activity, and the primary sap component is aloin/barbalion anthrone derivative. The sugars include monosaccharides (e.g., glucose and fructose) and polysaccarides (e.g., gluco-mannans and polymannose). As stated above, although not wishing to be bound to any particular constituent, it is believed that the active ingredient thereof is at least one or more of the constituents found in aloe vera. In addition, one or more of the at least one active ingredient of aloe vera can be a natural or synthetic component of the cleaning compositions herein.

Solvents which may be used in the cleaning compositions herein include, but are not limited to, water, alcohol, and mixtures thereof. In one embodiment, the solvent of the present invention can be that which is present in the hydrogen peroxide solution and also that which is added to further dilute a composition containing hydrogen peroxide and aloe vera.

In one embodiment of the invention, the cleaning composition comprises, by weight, from about 0.5% to about 15% hydrogen peroxide, from about 0.5% to about 75% aloe vera or at least one active ingredient thereof, and from about 99% to about 10% solvent. In this embodiment, the cleaning composition can also optionally include, by weight, from 0% to about 10% of at least one thickener, optionally include, by weight, from 0% to about 10% of at least one preservative, and/or optionally include, by weight, from 0% to about 10% of at least one chelating agent/compound, in place of an equal amount of solvent. Here, as well as elsewhere in the specification and claims, individual numerical values, or limits, from one or more embodiments can be combined to form additional non-disclosed and/or non-stated ranges.

Suitable thickeners include, but are not limited to, suitable personal care and/or cosmetic thickeners as known to those of skill in the art. Some non-limiting examples of suitable thickeners include, but are not limited to anionic polysaccharides (e.g., alginic acid, pectin, xanthan gum, hyaluronic acid, chondroitin sulfate, gum arabic, gum karaya, and/or gum tragacanth, carboxymethyl-chitin and/or cellulose gum), cationic polysaccharides (e.g., chitosan, cationic guar gum and/or cationic hydroxyethylcellulose (HEC)), nonionic polysaccharides (e.g., starch, dextrins, guar gum and/or cellulose ethers (e.g., hydroxyethylcellulose, methylcellulose, nitrocellulose)), amphoteric polysaccharides (e.g., carboxymethylchitosan, N-hydroxy-dicarboxyethyl-chitosan and/or modified potato starch), hydrophobic polysaccharides (e.g., cetyl hydroxyethylcellulose and/or polyquaternium 24), polyethylene glycol, synthetic polymers such as Carbomer® (a polyacrylic acid), vegetable gums, or suitable mixtures of two or more thereof.

Suitable preservatives include, but are not limited to, suitable personal care and/or cosmetic preservatives as known to those of skill in the art. Some non-limiting examples of suitable preservatives include, but are not limited to, sodium benzoate, citric acid, or mixtures thereof.

Suitable chelating agents/compounds include, but are not limited to, suitable personal care and/or cosmetic chelating agents (e.g., tetra sodium EDTA) as known to those of skill in the art.

Additionally, the compositions of the present invention can further optionally include any suitable amount of one or more common personal care additives. Such common personal care additives include, but are not limited to, pH balancers (e.g., triethanoilamine), a vitamin E compound and/or vitamin E derivative (e.g., Tocopheryl acetate), a stabilizer (e.g., a suitable EDTA compound), an antimicrobial preservative (e.g., diazolidinyl urea), a surfactant, an alkali carbonate, or suitable mixtures of any two or more thereof. Suitable amounts of any one or more of these common personal care additives include, by weight, from about 0.001% to about 10%, or from about 0.001% to about 7.5%, or from about 0.1 to about 7%, or from about 1% to about 6%, or from about 1.5% to about 5%, or even from about 2% to about 4%, in place of an equal amount of solvent.

Although the total amount of each component of the present invention may individually total more then 100 weight percent when each component is taken individually and totaled using the broadest amounts disclosed herein, one of skill in the art will realize that this is not the case. Rather, each individual component of a given composition of the present invention can be varied within any stated range as desired in order to achieve a total weight percent of 100.

In another embodiment, the cleaning composition includes, by weight, from about 1% to about 10% hydrogen peroxide, from about 1% to about 70% aloe vera or at least one active ingredient thereof, from about 0.1% to about 10% of at least one thickener, from about 0.1% to about 10% of at least one preservative, from about 0.1% to about 10% of at least one chelating agent and/or from about 97.7% to 0% solvent. In this embodiment, where there is no solvent component, the hydrogen peroxide component and/or the aloe vera component also acts as a solvent for the thickener component and/or the preservative component if need be. In yet another embodiment, the cleaning composition herein can include, by weight, from about 2% to about 8% hydrogen peroxide, from about 2% to about 65% aloe vera and/or at least one active ingredient thereof, from about 0.5% to about 8% of at least one thickener, from about 0.5% to about 8% of at least one preservative, from about 0.5% to about 8% of at least one chelating agent, and from about 94.5% to about 3% solvent. Here, as well as elsewhere in the specification and claims, individual numerical values, or limits, from one or more embodiments can be combined to form additional non-disclosed and/or non-stated ranges.

In still yet another embodiment, the cleaning composition herein can include, by weight, from about 2% to about 6% hydrogen peroxide, from about 2% to about 60% aloe vera and/or at least one active ingredient thereof, from about 1% to about 6% of at least one thickener, from about 1% to about 6% of at least one preservative, from about 1% to about 6% of at least one chelating agent and from about 93% to about 16% solvent. Here, as well as elsewhere in the specification and claims, individual numerical values, or limits, from one or more embodiments can be combined to form additional non-disclosed and/or non-stated ranges.

In still yet another embodiment, the amount of each component in the overall formulation can vary within the following stated ranges so long as the combination thereof totals to 100 weight percent. The compositions of the present invention can contain, by weight, from about 1% to about 10% hydrogen peroxide, from about 1.5% to about 9% hydrogen peroxide, from about 2% to about 8% hydrogen peroxide, from about 2.5% to about 7% hydrogen peroxide, from about 3% to about 6% hydrogen peroxide, or from about 3.5% to about 5.5% hydrogen peroxide, or even from about 4% to about 5% hydrogen peroxide. The compositions of the present invention can contain, by weight, from about 1.5% to about 60% aloe vera and/or at least one active ingredient thereof, from about 2% to about 60% aloe vera and/or at least one active ingredient thereof, from about 2.5% to about 55% aloe vera and/or at least one active ingredient thereof, from about 5% to about 50% aloe vera and/or at least one active ingredient thereof, from about 10% to about 45% aloe vera and/or at least one active ingredient thereof, from about 12.5% to about 40% aloe vera and/or at least one active ingredient thereof, from about 15% to about 35% aloe vera and/or at least one active ingredient thereof, from about 17.5% to about 30% aloe vera and/or at least one active ingredient thereof, or even from about 20% to about 25% aloe vera and/or at least one active ingredient thereof. The compositions of the present invention can contain, by weight, from about 1.5% to about 7.5% of at least one thickener, from about 2% to about 5% of at least one thickener, or even from about 2.5% to about 4% of at least one thickener. The compositions of the present invention can contain, by weight, from about 1.5% to about 7.5% of at least one preservative, from about 2% to about 5% of at least one preservative, or even from about 2.5% to about 4% of at least one preservative. The compositions of the present invention can contain, by weight, from about 1.5% to about 7.5% of at least one chelating agent, from about 2% to about 5% of at least one chelating agent, or even from about 2.5% to about 4% of at least one chelating agent. Here, as well as elsewhere in the specification and claims, individual numerical values, or limits, from one or more embodiments can be combined to form additional non-disclosed and/or non-stated ranges.

In another embodiment, it may be desirable that the cleaning compositions of the present invention further contain a fragrance or perfume for use on surfaces which do not come in contact with food. Such surfaces include hard surfaces and soft surfaces such as textiles, fabrics, upholstery and carpet, for example. Accordingly, in another embodiment of the present invention, a disinfectant cleaning composition comprises hydrogen peroxide, H₂O₂, aloe vera or at least one active ingredient thereof, at least one fragrance and at least one solvent. In another embodiment, the fragrance is a water-soluble fragrance.

Fragrances selected for use in the cleaning compositions in accordance with an embodiment of the present invention contain ingredients which provide a fresh impression in the area or on the surface to which the composition is directed. Fragrance material of the cleaning composition can include, but are not limited to, aromatic and aliphatic esters having molecular weights from about 130 to about 250; aliphatic and aromatic alcohols having molecular weights from about 90 to about 240; aliphatic ketones having molecular weights from about 150 to about 260; aromatic ketones having molecular weights from about 150 to about 270; aromatic and aliphatic lactones having molecular weights from about 130 to about 290; aliphatic aldehydes having molecular weights from about 140 to about 200; aromatic aldehydes having molecular weights from about 90 to about 230; aliphatic and aromatic ethers having molecular weights from about 150 to about 270; and condensation products of aldehydes and amines having molecular weights from about 180 to about 320 and mixtures thereof. When high initial fragrance impact on fabrics is desired, it is also preferable to select a fragrance containing ingredients which are not too hydrophobic. The less hydrophobic fragrance ingredients are more soluble in water, and are more available in the freshening composition. Identification of water-soluble fragrances are well known to those of ordinary skill in the art and water-soluble fragrances are commercially available from a wide variety of sources.

In one embodiment of the invention, the cleaning composition comprises, by weight, from about 0.5% to about 15% hydrogen peroxide, from about 0.5% to about 45% aloe vera or at least one active ingredient thereof, from about 0.05% to about 10% fragrance, and from about 98.95% to about 30% solvent. In this embodiment, the cleaning composition can also optionally include, by weight, from 0% to about 10% of at least one thickener, optionally include, by weight, from 0% to about 10% of at least one preservative, and/or optionally include, by weight, from 0% to about 10% of at least one chelating agent/compound, in place of an equal amount of solvent.

In another embodiment, the cleaning composition includes, by weight, from about 1% to about 10% hydrogen peroxide, from about 1% to about 40% aloe vera and/or at least one active ingredient thereof, from about 0.05% to about 5% fragrance, and from about 97.5% to about 45% solvent. In this embodiment, the cleaning composition can also optionally include, by weight, from about 0.1% to about 8% of at least one thickener, optionally include, by weight, from about 0.1% to about 8% of at least one preservative, and/or optionally include, by weight, from about 0.1% to about 8% of at least one chelating agent/compound, in place of an equal amount of solvent.

In yet another embodiment, the cleaning composition includes, by weight, from about 1% to about 5% hydrogen peroxide, from about 1% to about 30% aloe vera or at least one active ingredient thereof, from about 0.1% to about 4% fragrance, and from about 97.9% to about 61% solvent. In this embodiment, the cleaning composition can also optionally include, by weight, from about 0.5% to about 6% of at least one thickener, optionally include, by weight, from about 0.5% to about 6% of at least one preservative, and/or optionally include, by weight, from about 0.5% to about 6% of at least one chelating agent/compound, in place of an equal amount of solvent.

In still yet another embodiment, the cleaning composition herein can include by weight, from about 2% to about 4% hydrogen peroxide, from about 2% to about 25% aloe vera or at least one active ingredient thereof, from about 0.2% to about 2% fragrance and from about 95.8% to about 69% solvent. In this embodiment, the cleaning composition can also optionally include, by weight, from about 1% to about 4% of at least one thickener, optionally include, by weight, from about 1% to about 4% of at least one preservative, and/or optionally include, by weight, from about 1% to about 4% of at least one chelating agent/compound, in place of an equal amount of solvent. Again, here, as well as elsewhere in the specification and claims, individual numerical values, or limits, from one or more embodiments can be combined to form additional non-disclosed and/or non-stated ranges.

In another embodiment of the present invention, the cleaning compositions herein may comprise a fragrance which is an essential oil or at least one active ingredient thereof, and a glycol ether which can function as a coupling agent. Accordingly, in another embodiment of the present invention, the cleaning compositions comprise hydrogen peroxide, aloe vera or at least one active ingredient thereof, an essential oil or at least one active ingredient thereof, glycol ether, and solvent.

Essential oils include, but are not limited to, those obtained from thyme, lemongrass, citrus, lemons, oranges, anise, clove, aniseed, geranium, roses, mint, lavender, citronella, eucalyptus, peppermint, camphor, sandalwood, pine, vervain, rosmarin, fleagrass, ratanhiae, cedar and mixtures of two or more thereof. Actives of essential oils for use herein include, but are not limited to, thymol (present for example in thyme), eugenol (present for example in clove), menthol (present for example in mint), geraniol (present for example in geranium and rose), verbenone (present for example in vervain), eucalyptol and pinocarvone (present in eucalyptus), cedrol (present for example in cedar), anethol (present for example in anise), carvacrol, hinokitiol, berberine, ferulic acid, methyl salicylic acid, methyl salicylate, terpineol and mixtures thereof.

Glycol ether materials are excellent solvents and coupling agents and are typically miscible with aqueous cleaning compositions of the invention. The boiling points of the materials fall within a range of about 100° C. to about 250° C. The cleaning composition according to various embodiments of the present invention includes at least one glycol ether, for example, one or more glycol ether according to the following formulas R₁—OCH₂CH₂OH, R₁—OCH₂CH₂OCH₂CH₂OH, R₁—OCH₂CH₂O—R₂, where R₁ and R₂ are independently selected from C₁ to C₁₀ linear alkyl groups, C₂ to C₁₀ branched alkyl groups, or C₁ to C₅ linear alkyl groups, or even C₂ to C₅ branched alkyl groups). Examples of glycol ether include, but are not limited to, propylene glycol ether, dipropylene glycol ether, tripropylene glycol ether, propylene glycol methyl ether, dipropylene glycol methyl ether, dipropylene glycol ethyl ether, tripropylene glycol methyl ether, propylene glycol isobutyl ether, ethylene glycol methyl ether, ethylene glycol ethyl ether, ethylene glycol diethyl ether, ethylene glycol dibutyl ether, diethylene glycol methyl ether, diethylene glycol dimethylether, diethylene glycol ethyl ether, diethylene glycol diethyl ether, diethylene glycol butyl ether, ethylene glycol dimethyl ether and other similar materials and mixtures thereof.

Therefore, in one embodiment of the invention, the cleaning composition comprises, by weight, from about 0.5% to about 15% hydrogen peroxide, from about 0.5% to about 45% aloe vera or at least one active ingredient thereof, from about 0.05% to about 5% essential oil, from about 0.5% to about 10% glycol ether, and from about 98.45% to about 25% solvent. In this embodiment, the cleaning composition can also optionally include, by weight, from about 0.1% to about 10% of at least one thickener, optionally include, by weight, from about 0.1% to about 10% of at least one preservative, and/or optionally include, by weight, from about 0.1% to about 10% of at least one chelating agent/compound, in place of an equal amount of solvent.

In another embodiment, the cleaning composition includes, by weight, from about 1% to about 10% hydrogen peroxide, from about 1% to about 40% aloe vera or at least one active ingredient thereof, from about 0.1% to about 4% essential oil, from about 1% to about 5% glycol ether, and from about 96.9% to about 41% solvent. In this embodiment, the cleaning composition can also optionally include, by weight, from about 0.1% to about 10% of at least one thickener, optionally include, by weight, from about 0.1% to about 10% of at least one preservative, and/or optionally include, by weight, from about 0.1% to about 10% of at least one chelating agent/compound, in place of an equal amount of solvent.

In another embodiment, the cleaning composition includes, by weight, from about 1% to about 6% hydrogen peroxide, from about 1% to about 30% aloe vera and/or at least one active ingredient thereof, from about 0.1% to about 2% essential oil, from about 1% to about 5% glycol ether, and from about 96.9% to about 57% solvent. In this embodiment, the cleaning composition can also optionally include, by weight, from about 0.1% to about 10% of at least one thickener, optionally include, by weight, from about 0.1% to about 10% of at least one preservative, and/or optionally include, by weight, from about 0.1% to about 10% of at least one chelating agent/compound, in place of an equal amount of solvent.

In yet another embodiment, the cleaning composition herein can include by weight, from about 2% to about 4% hydrogen peroxide, from about 2% to about 30% aloe vera or at least one active ingredient thereof, from about 0.2% to about 1% essential oil, from about 1% to about 3% glycol ether, and from about 94.8% to about 62% solvent. In this embodiment, the cleaning composition can also optionally include, by weight, from about 0.1% to about 10% of at least one thickener, optionally include, by weight, from about 0.1% to about 10% of at least one preservative, and/or optionally include, by weight, from about 0.1% to about 10% of at least one chelating agent/compound, in place of an equal amount of solvent. In these embodiments, suitable solvents include, but are not limited to, water, alcohol, and mixtures thereof.

In another embodiment of the present invention, alternate sources for hydrogen peroxide can be used to make any of the various cleaning compositions disclosed herein. Given this, whenever “hydrogen peroxide” is referred to throughout the specification and claims, such hydrogen peroxide can be replaced by an adequate amount of one or more hydrogen peroxide producing sources. Suitable hydrogen peroxide producing sources are described below. However, depending upon the hydrogen peroxide producing source, the compositions of the present invention may be designed for use on surfaces other than those which come into contact with food. A hydrogen peroxide producing source can be any compound which produces hydrogen peroxide when the compound is in contact with water. Suitable water-soluble sources of hydrogen peroxide for use herein include, but are not limited to, percarbonates (e.g., alkali percarbonates such as one or more sodium percarbonates), persilicates, persulfates, such as monopersulfate, perborates and peroxyacids such as diperoxydodecandioic acid (DPDA), magnesium perphthalic acid and mixtures thereof. In another embodiment of the invention, the cleaning composition comprises a mixture of hydrogen peroxide and at least one hydrogen peroxide producing source.

In one embodiment of the invention, the cleaning composition comprises, by weight, from about 0.5% to about 15% of at least one of hydrogen peroxide and/or hydrogen peroxide producing source, from about 1.5% to about 55% aloe vera or active ingredient thereof, and from about 99% to about 30% water. In this embodiment, the cleaning composition can also optionally include, by weight, from about 0.1% to about 10% of at least one thickener, optionally include, by weight, from about 0.1% to about 10% of at least one preservative, and/or optionally include, by weight, from about 0.1% to about 10% of at least one chelating agent/compound, in place of an equal amount of solvent.

In another embodiment, the cleaning composition includes, by weight, from about 1% to about 15% of at least one of hydrogen peroxide and/or hydrogen peroxide producing source, from about 2% to about 45% aloe vera or at least one active ingredient thereof, and from about 98% to about 40% water. In this embodiment, the cleaning composition can also optionally include, by weight, from about 0.1% to about 10% of at least one thickener, optionally include, by weight, from about 0.1% to about 10% of at least one preservative, and/or optionally include, by weight, from about 0.1% to about 10% of at least one chelating agent/compound, in place of an equal amount of solvent.

In yet another embodiment, the cleaning composition herein can include by weight, from about 2% to about 6% hydrogen peroxide, from about 2.5% to about 30% aloe vera and/or at least one active ingredient thereof, and from about 96% to about 64% solvent. In this embodiment, the cleaning composition can also optionally include, by weight, from about 0.1% to about 10% of at least one thickener, optionally include, by weight, from about 0.1% to about 10% of at least one preservative, and/or optionally include, by weight, from about 0.1% to about 10% of at least one chelating agent/compound, in place of an equal amount of solvent. In yet another embodiment, the cleaning composition herein can include by weight, from about 2% to about 4% of at least one of hydrogen peroxide and hydrogen peroxide producing source, from about 3% to about 28% aloe vera or at least one active ingredient thereof, and from about 96% to about 68% water. In this embodiment, the cleaning composition can also optionally include, by weight, from about 0.1% to about 10% of at least one thickener, optionally include, by weight, from about 0.1% to about 10% of at least one preservative, and/or optionally include, by weight, from about 0.1% to about 10% of at least one chelating agent/compound, in place of an equal amount of solvent. Again, here, as well as elsewhere in the specification and claims, individual numerical values, or limits, from one or more embodiments can be combined to form additional non-disclosed and/or non-stated ranges.

In addition, alternative embodiments of the cleaning compositions herein can include other classes of peroxides that can be used as an alternative to the above at least one of hydrogen peroxide and/or hydrogen peroxide producing source. Such cleaning compositions herein may be used on surfaces, hard or soft surfaces for example, which do not come in contact with food.

In yet another embodiment, the cleaning compositions of the present invention can be utilized in various personal care and/or cosmetic applications. In another embodiment, these classes of peroxides other than hydrogen peroxide can also be used in combination with hydrogen peroxide and sources of hydrogen peroxide. Suitable classes of peroxides other than hydrogen peroxide can include, but are not limited to, dialkylperoxides, diacylperoxides, preformed percarboxylic acids, organic and inorganic peroxides and/or hydroperoxides. Thus, the cleaning compositions herein comprise peroxide, aloe vera or at least one active ingredient thereof, and solvent. Suitable solvents include, but are not limited to, water, one or more alcohols, and mixtures of two or more thereof.

The various embodiments of the cleaning composition described above can also include one or more optional ingredients. Optional ingredients of the cleaning compositions of the present invention can include, depending upon the substrate being cleaned, all such typically utilized ingredients as are known by those of skill in the art for the purpose of disinfecting and cleaning, for aesthetics, or otherwise. For substrates which do not come into contact with food, the optional ingredients may include, but are not limited to, disinfectants such as bleaches (e.g., peroxygen bleaches and/or chlorine-type bleaches), aldehydes, glyoxal, parabens, pbiguanide antimicrobial agents, peroxy acids, and mixtures thereof.

An effective amount of disinfecting material is the amount sufficient to allow the disinfecting material to perform its action in reducing the number of micro-organisms existing on a given surface. Depending on the disinfecting material used, the amount used may be different.

In another embodiment of the present invention, the cleaning composition comprises hydrogen peroxide, H₂O₂, aloe vera and/or at least one active ingredient thereof, at least one solvent, and is substantially free of any additional disinfectants. For example, in one embodiment the cleaning compositions of the present invention are substantially free of alcohols, such as for example ethyl alcohol, is substantially free of chlorinated compounds, such as for example, hypochlorites, for example sodium hypochlorite, and quaternary ammonium compounds, for example salts of quaternary ammonium chlorides.

In still another embodiment, the present invention relates to any of the cleaning compositions disclosed herein that contain a suitable amount of at least one thickener to produce a gel. Cleaning gels are known in the art and as such the amount of thickener necessary to produce same is also known to those of skill in the art.

In still another embodiment, the present invention relates to a cleaning composition that comprises, by weight, from about 20% to about 40% of at least one alkali percarbonate (e.g., sodium percarbonate) or other hydrogen peroxide producing source, from about 20% to about 40% of at least one alkali carbonate (e.g., sodium carbonate), and from about 40% to about 20% of aloe vera or at least one active ingredient thereof. In another embodiment, the above composition can also include up to about 10% by weight of one or more surfactants in place of any one or more of the three main components of this formulation. In still another embodiment, the compositions of this embodiment can further optionally include one or more fragrances in addition to the aforementioned three or four components above.

In still yet another embodiment, the present invention relates to a cleaning composition that is dry or in powdered form that comprises, by weight, from about 20% to about 40% of at least one alkali percarbonate (e.g., sodium percarbonate) or other hydrogen peroxide producing source, from about 20% to about 40% of at least one alkali carbonate (e.g., sodium carbonate), and from about 40% to about 20% of aloe vera or at least one active ingredient thereof. In another embodiment, the above composition can also include up to about 10% by weight of one or more surfactants in place of any one or more of the three main components of this formulation. In still another embodiment, the compositions of this embodiment can further optionally include one or more fragrances in addition to the aforementioned three or four components above.

In still another embodiment, either of the two cleaning compositions discussed immediately above can comprise, by weight, from about 25% to about 35% of at least one alkali percarbonate (e.g., sodium percarbonate) or other hydrogen peroxide producing source, from about 25% to about 35% of at least one alkali carbonate (e.g., sodium carbonate), and from about 35% to about 25% of aloe vera or at least one active ingredient thereof. In another embodiment, the above composition can also include up to about 7.5%, or even up to about 5%, by weight of one or more surfactants in place of any one or more of the three main components of this formulation. In still another embodiment, the compositions of this embodiment can further optionally include one or more fragrances in addition to the aforementioned three or four components above. Again, here, as well as elsewhere in the specification and claims, individual numerical values, or limits, from one or more embodiments can be combined to form additional non-disclosed and/or non-stated ranges.

The cleaning compositions of the present invention may be applied directly on to the area to be treated or applied using a cloth or piece of material such as a spring device or aerosol can, a sponge, a brush or other mechanical/electrical device. The spraying device may be trigger operated, pump operated, electrically operated or operated by any such pressurized gas such as a can or a pressurizer. The spraying devices ensure uniform coverage of the area to be treated and maximizes the advantage of using liquid aqueous compositions.

The method for cleaning a substrate includes contacting the disinfectant cleaning composition to a surface, for example a hard surface or a soft surface such as textile, fabric and/or upholstery, and optionally, rinsing the surface. In another embodiment, the method further comprises the step of incorporating the composition into a wipe and contacting the wipe on the surface to be cleaned. In another embodiment, the method can further include applying energy to the substrate and contacting the fabric with an absorbing material. In another embodiment, the method further comprises rinsing the surface with a solvent, for example water, to remove the stain and/or soils and any residual disinfectant cleaning composition herein. However, it is not necessary to rinse and in another embodiment the method comprises washing the substrate.

Various embodiments of the invention have been described. However, it should be understood that many variations and modifications may be made while remaining within the spirit and scope of the invention.

What is claimed is:

1. A cleaning composition comprising:
from about 0.5% to about 15% by weight hydrogen peroxide;
from about 1.5% to about 75% by weight aloe vera and/or at least one antibacterial, antifungal and/or antiviral active component thereof; and
from about 99% to about 10% by weight of at least one solvent.

2. The cleaning composition of claim 1, wherein the solvent is water.

3. The cleaning composition of claim 1, further comprising at least one fragrance.

4. The cleaning composition of claim 3, wherein the solvent is water.

5. The cleaning composition of claim 3, wherein the fragrance is water soluble.

6. The cleaning composition of claim 3, wherein the fragrance is selected from the group of: aromatic and aliphatic esters, aliphatic and aromatic alcohols, aromatic and aliphatic ketones, aromatic and aliphatic lactones, aromatic and aliphatic aldehydes, aromatic aldehydes, aliphatic and aromatic ethers, condensation products of aldehydes and amines, and mixtures thereof.

7. The cleaning composition of claim 6, wherein the solvent is water.

8. The cleaning composition of claim 1, wherein the at least one antibacterial, antifungal and/or antiviral active component is selected from one or more anthraquinones that are present in aloe vera.

9. The cleaning composition of claim 1, wherein the cleaning composition is a disinfectant cleaning composition.

10. The cleaning composition of claim 1, wherein the cleaning composition optionally includes from about 0.1% to about 10% of at least one thickener, optionally includes, by weight, from about 0.1% to about 10% of at least one preservative, and/or optionally includes, by weight, from about 0.1% to about 10% of at least one chelating agent/compound, where such additional components are in place of a similar amount of solvent.

11. A cleaning composition comprising:
from about 1% to about 15% by weight hydrogen peroxide;
from about 2% to about 65% by weight aloe vera and/or at least one antibacterial, antifungal and/or antiviral active component thereof; and
from about 98% to about 20% by weight solvent.

12. The cleaning composition of claim 11, wherein the solvent is water.

13. The cleaning composition of claim 11, wherein the at least one antibacterial, antifungal and/or antiviral active component is selected from one or more anthraquinones that are present in aloe vera.

14. The cleaning composition of claim 11, wherein the cleaning composition optionally includes from about 0.1% to about 10% of at least one thickener, optionally includes, by weight, from about 0.1% to about 10% of at least one preservative, and/or optionally includes, by weight, from about 0.1% to about 10% of at least one chelating agent/compound, where such additional components are in place of a similar amount of solvent.

15. The cleaning composition of claim 11, wherein the cleaning composition is a disinfectant cleaning composition.

16. A cleaning composition comprising:
from about 2% to about 6% by weight hydrogen peroxide;
from about 2.5% to about 60% by weight aloe vera and/or at least one antibacterial, antifungal and/or antiviral active component thereof; and
from about 96% to about 34% solvent.

17. The cleaning composition of claim 16, wherein the at least one antibacterial, antifungal and/or antiviral active component is selected from one or more anthraquinones that are present in aloe vera.

18. The cleaning composition of claim 16, wherein the cleaning composition optionally includes from about 0.1% to about 10% of at least one thickener, optionally includes, by weight, from about 0.1% to about 10% of at least one preservative, and/or optionally includes, by weight, from about 0.1% to about 10% of at least one chelating agent/compound, where such additional components are in place of a similar amount of solvent.

19. The cleaning composition of claim 16, wherein the cleaning composition is a disinfectant cleaning composition.

20. A cleaning composition comprising:
from about 1% to about 15% by weight hydrogen peroxide;
from about 1.5% to about 50% by weight aloe vera and/or at least one antibacterial, antifungal and/or antiviral active component thereof;
from about 0.05% to about 5% by weight fragrance; and
from about 97.5% to about 35% by weight solvent.

21. The cleaning composition of claim 20, wherein the solvent is water.

22. The cleaning composition of claim 20, wherein the hydrogen peroxide is derived from one or more hydrogen peroxide producing sources.

23. The cleaning composition of claim 20, wherein the at least one antibacterial, antifungal and/or antiviral active component is selected from one or more anthraquinones that are present in aloe vera.

24. The cleaning composition of claim 20, wherein the cleaning composition optionally includes from about 0.1% to about 10% of at least one thickener, optionally includes, by weight, from about 0.1% to about 10% of at least one preservative, and/or optionally includes, by weight, from about 0.1% to about 10% of at least one chelating agent/compound, where such additional components are in place of a similar amount of solvent.

25. The cleaning composition of claim 20, wherein the cleaning composition is a disinfectant cleaning composition.

26. A cleaning composition comprising:
from about 25% to about 35% by weight of at least one alkali percarbonate or other hydrogen peroxide producing source;
from about 25% to about 35% by weight of at least one alkali carbonate;
from about 35% to about 25% of aloe vera or at least one active ingredient thereof; and
from about 15% to about 5% of at least one surfactant.

27. The cleaning composition of claim 26, wherein the at least one alkali percarbonate is a sodium percarbonate

28. The cleaning composition of claim 26, wherein the at least one alkali carbonate is sodium carbonate.

29. The cleaning composition of claim 26, wherein the cleaning composition is in powdered form.

30. A method for cleaning a substrate comprising the step of:
contacting a cleaning composition to a surface, wherein the cleaning composition comprises:
from about 0.5% to about 15% by weight hydrogen peroxide;
from about 1.5% to about 75% by weight aloe vera and/or at least one antibacterial, antifungal and/or antiviral active component thereof; and
from about 99% to about 10% by weight of at least one solvent.

31. The method of claim 30, further comprising applying energy to the substrate.

32. The method of claim 30, wherein the method comprises no rinsing of the substrate containing the disinfectant cleaning composition.

33. The method of claim 30, wherein the cleaning composition optionally includes from about 0.1% to about 10% of at least one thickener, optionally includes, by weight, from about 0.1% to about 10% of at least one preservative, and/or optionally includes, by weight, from about 0.1% to about 10% of at least one chelating agent/compound, where such additional components are in place of a similar amount of solvent.
